(19) United States
(12) Patent Application Publication
(10) Pub. No.: US 2017/0176253 A1
(43) Pub. Date: Jun. 22, 2017

(54) OPTICAL ARRANGEMENTS AND METHODS FOR CONTROLLING AN OPTICAL ARRANGEMENT

(71) Applicant: EINST Technology Pte Ltd, Singapore (SG)

(72) Inventors: Khay Ming Eddie TAN, Singapore (SG); Wee Lee Tok, Singapore (SG); Wee Keong Tok, Singapore (SG)

(21) Appl. No.: 15/304,871

(22) PCT Filed: Jul. 7, 2015
(86) PCT No.: PCT/SG2015/050200

§ 371 Date: Oct. 18, 2016

(51) Int. Cl. G01J 3/02; G01J 3/42; G02B 6/44; G01N 21/552

(52) U.S. Cl. CPC G01J 3/0218; G01N 21/552; G01J 3/42; G02B 6/4471; G01N 2201/0846; G01N 2201/06113; G01N 2201/062

(57) ABSTRACT

According to various embodiments, an optical arrangement may be provided. The optical arrangement may include: a bifurcated fiber comprising a distal end and a bifurcated end; wherein the bifurcated end comprises a first end configured to be connected to a spectrometer and a second end configured to be connected to an illuminator; wherein the bifurcated end is connected to the distal end via a 1-to-2 spliced fiber.

### TECHNICAL FIELD

Embodiments relate generally to optical arrangements and methods for controlling an optical arrangement.

Background

Ultraviolet Visible Near-Infra red (UV-Vis-NIR) spectroscopy may be useful to characterize the absorption, transmission, and reflectivity of a variety of materials, such as graphene, pigment, pharmaceutical tablets, etc. Absorption, transmission and reflection (ATR) spectroscopy coupled to a microscope may offer superior capability for investigating small sized samples. When the microscope is equipped with a motorized stage, a user may be able to carry out mapping of the entire sample allowing the user to have a bird's eye view of the overall optical properties distribution across the sample.

However, ensuring micrometer or sub-micrometer scale accuracy in this micro-spectroscopy technique may be tedious and may require extensive alignment and constant checks. Mechanical stability may also play an important part with thermal drift and vibration easily affecting the required micron or sub-micron accuracy of the collected data.

Currently available methods and systems may suffer two main issues: (1) accuracy of the exact collection position in XYZ axis, and (2) exact collection spot size.

Thus, there may be a need for improved devices and methods addressing these issues.

### SUMMARY

According to various embodiments, an optical arrangement may be provided. The optical arrangement may include: a bifurcated fiber comprising a distal end and a bifurcated end; wherein the bifurcated end comprises a first end configured to be connected to a spectrometer or any detection device and a second end configured to be connected to an illuminator; wherein the bifurcated ends are connected to the distal end via a 1-to-2 spliced fiber.

According to various embodiments, a method for controlling an optical arrangement may be provided. The method may include: illuminating a second end of a bifurcated end of a bifurcated fiber; analysing a spectrum using a spectrometer or any detection device connected to a first end of the bifurcated end of the bifurcated fiber; wherein the bifurcated fiber further comprises a distal end; and wherein the bifurcated end is connected to the distal end via a 1-to-2 spliced fiber.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows an optical arrangement according to various embodiments;

FIG. 1B shows a flow diagram illustrating a method for controlling an optical arrangement according to various embodiments;

FIG. 2 shows a schematic diagram of an ATR micro-spectroscopy system according to various embodiments and an ATR module layout according to various embodiments; and

FIG. 3A, FIG. 3B, and FIG. 3C show schematic diagrams of three example of different fiber arrangements in the bifurcated fiber according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

Ultraviolet Visible Near-Infra red (UV-Vis-NIR) spectroscopy may be useful to characterize the absorption, transmission, and reflectivity of a variety of materials, such as graphene, pigment, pharmaceutical tablets, etc. Absorption, transmission and reflection (ATR) spectroscopy coupled to a microscope may offer superior capability for investigating small sized samples. When the microscope is equipped with a motorized stage, a user may be able to carry out mapping of the entire sample allowing the user to have a bird's eye view of the overall optical properties distribution across the sample.

However, ensuring micrometer or sub-micrometer scale accuracy in this micro-spectroscopy technique may be tedious and may require extensive alignment and constant checks. Mechanical stability may also play an important part with thermal drift and vibration easily affecting the required micron or sub-micron accuracy of the collected data.

Currently available methods and systems may suffer two main issues: (1) accuracy of the exact collection position in XYZ axis, and (2) exact collection spot size.

According to various embodiments, devices and methods may be provided which address these issues.

According to various embodiments, a setup attachment technique may be provided which 1) can be used on any microscopes, 2) offers the function to accurately mark the location where the signal is taken from, and 3) offers accurate documentation of the spot size.

According to various embodiments, a fiber optic ATR micro-spectroscopy system and method may be provided.

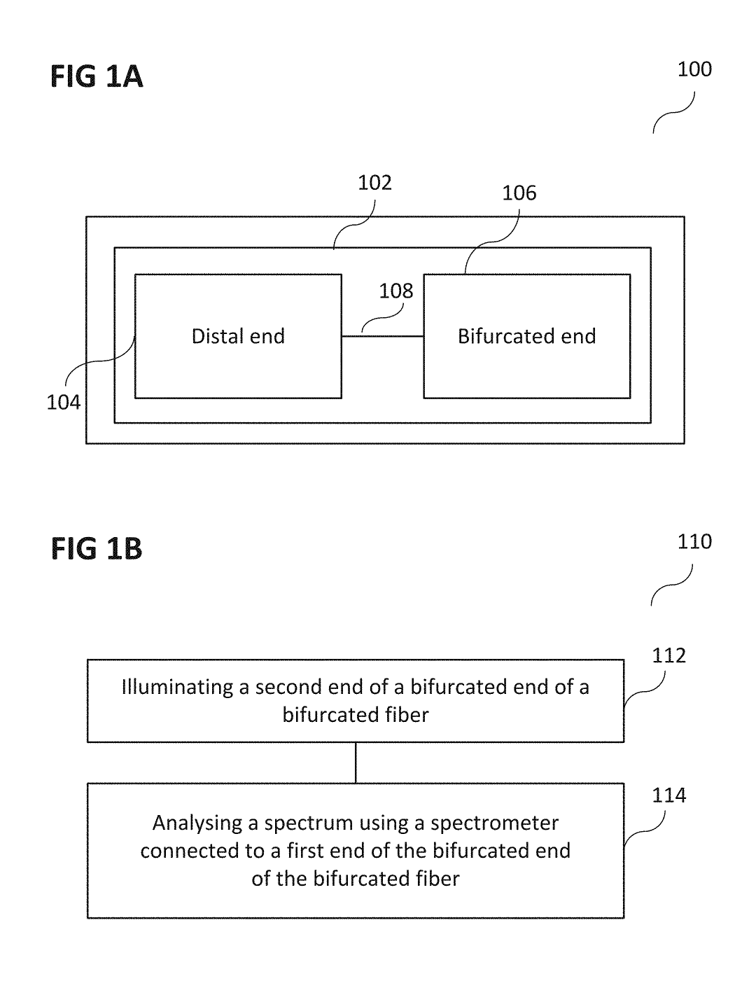

FIG. 1A shows an optical arrangement 100 according to various embodiments. The optical arrangement 100 may include a bifurcated fiber 102. The bifurcated fiber 102 may include a distal end 104 and a bifurcated end 106. The bifurcated end 106 may include a first end configured to be connected to a spectrometer or any detection device and a second end configured to be connected to an illuminator. The first end may be connected to a center portion of the distal end 104. The bifurcated end 106 may be connected to the distal end via a 1-to-2 spliced fiber.

In other words, a bifurcated fiber may be provided, wherein a center portion of the bifurcated end of the bifurcated fiber is connected to the other (non-bifurcated) end of the bifurcated fiber.

According to various embodiments, the distal end 104 may include or may be or may be included in a single core fiber.

According to various embodiments, the first end may include or may be or may be included in a single core fiber.

According to various embodiments, the second end may include or may be or may be included in a single core fiber.

According to various embodiments, the bifurcated end 106 may be connected to the distal end 104 via a 1-to-2 spliced fiber.

According to various embodiments, the second end may include or may be or may be included in a plurality of single core fibers.

According to various embodiments, the second end may include or may be or may be included in six single core fibers.

According to various embodiments, the second end may include or may be or may be included in nine single core fibers.

According to various embodiments, the distal end may include or may be or may be included in a plurality of single core fibers, wherein a center single core fiber of the plurality of single core fibers of the distal end may be connected to the first end, and wherein the center single core fiber may be surrounded by single core fibers connected to the plurality of single core fibers of the second end.

FIG. 1B shows a flow diagram 110 illustrating a method for controlling an optical arrangement according to various embodiments. In 112, a second end of a bifurcated end of a bifurcated fiber may be illuminated. In 114, a spectrum may be analysed using a spectrometer connected to a first end of the bifurcated end of the bifurcated fiber. The bifurcated fiber may further include a distal end. The bifurcated end may be connected to the distal end via a 1-to-2 spliced fiber.

According to various embodiments, the distal end may include or may be or may be included in a single core fiber.

According to various embodiments, the first end may include or may be or may be included in a single core fiber.

According to various embodiments, the second end may include or may be or may be included in a single core fiber.

According to various embodiments, the bifurcated end may be connected to the distal end via a 1-to-2 spliced fiber.

According to various embodiments, the second end may include or may be or may be included in a plurality of single core fibers.

According to various embodiments, the second end may include or may be or may be included in six single core fibers.

According to various embodiments, the second end may include or may be or may be included in nine single core fibers.

According to various embodiments, the distal end may include or may be or may be included in a plurality of single core fibers, wherein a center single core fiber of the plurality of single core fibers of the distal end may be connected to the first end, and wherein the center single core fiber may be surrounded by single core fibers connected to the plurality of single core fibers of the second end.

In a system or method according to various embodiments, ATR data or any emission data collected from the objective may be coupled to a spectrometer via an optical fiber. Although the microscope objective may have a wide field of view, depending on the objective magnification, the actual area of interest may be limited to the diameter of the fiber as aligned to the focal plane of the collection lens with known focal length. The area of investigation may be reduced by using higher magnification microscope objective, the field of view however may still be larger than the collection fiber core.

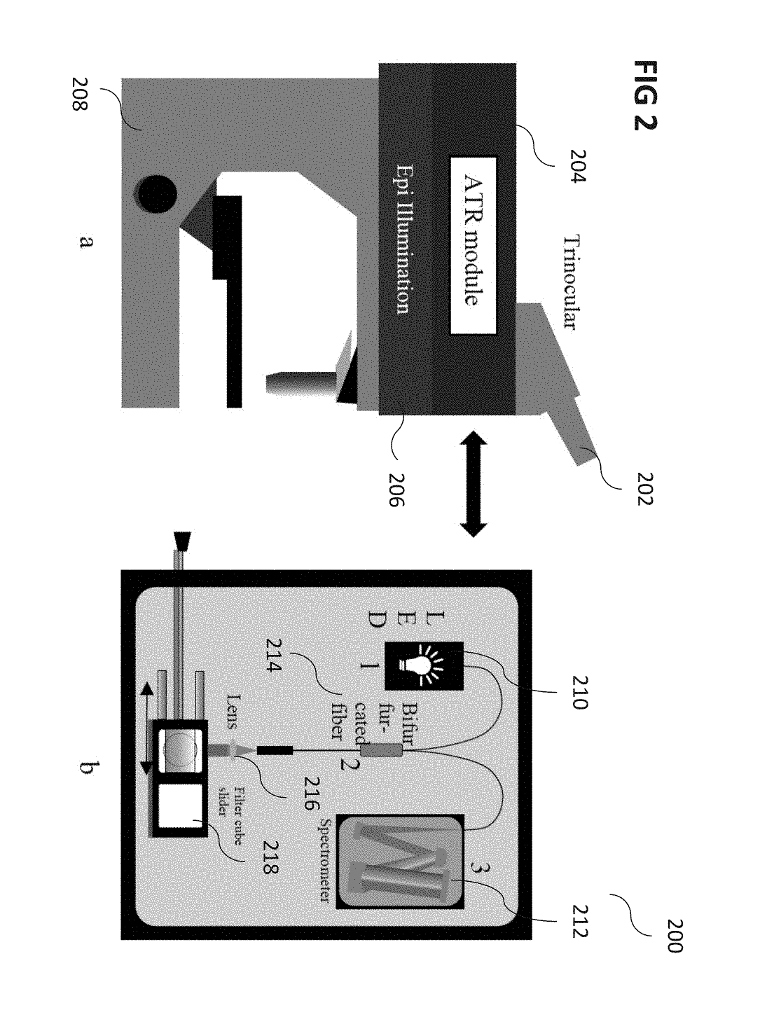

Additionally a critical illumination spot may be shone on the sample, through the same fiber using either a bifurcated multi-core arrangement or a spliced 1-to-2 coupler, to indicate the exact collection location. The same illumination spot may also be measured using the traditional microscope camera or using micrometer reticle scale on the eyepiece to accurately define the collection spot dimension. The setup is shown in FIG. 2.

FIG. 2 shows a schematic diagram 200 of (a) an ATR micro-spectroscopy system according to various embodiments and (b) an ATR module layout according to various embodiments. In other words, FIG. 2 depicts a schematic diagram 200 of (a) ATR micro-spectroscopy system and (b) the internal component layout.

In the ATR micro-spectroscopy system, an ATR module 204 may be mounted on a upright (or inverted) microscope 208 between an epi-illumination module 206 and a trinocular head 202.

In the ATR module layout as shown in portion (b) of FIG. 2, the main components are
1) LED (or low power Laser, or any light source) module 210;
2) Bifurcated optical fiber 214 (for example 1:2 coupler or multi-core fiber assembly);
3) Spectrometer 212 (or any detection device).

Furthermore, a lens 216 and a fiber cube slider 218 may be provided.

During ATR measurement, the microscope may provide the main light source either through epi-illumination or transmission illumination. The microscope objective may be used for both illumination (only epi-illumination) and collection of ATR signal. To indicate the location where the collection will be, a LED may be used for illumination of the location on the sample. This may be done through launching the LED light into one end of the bifurcated fiber.

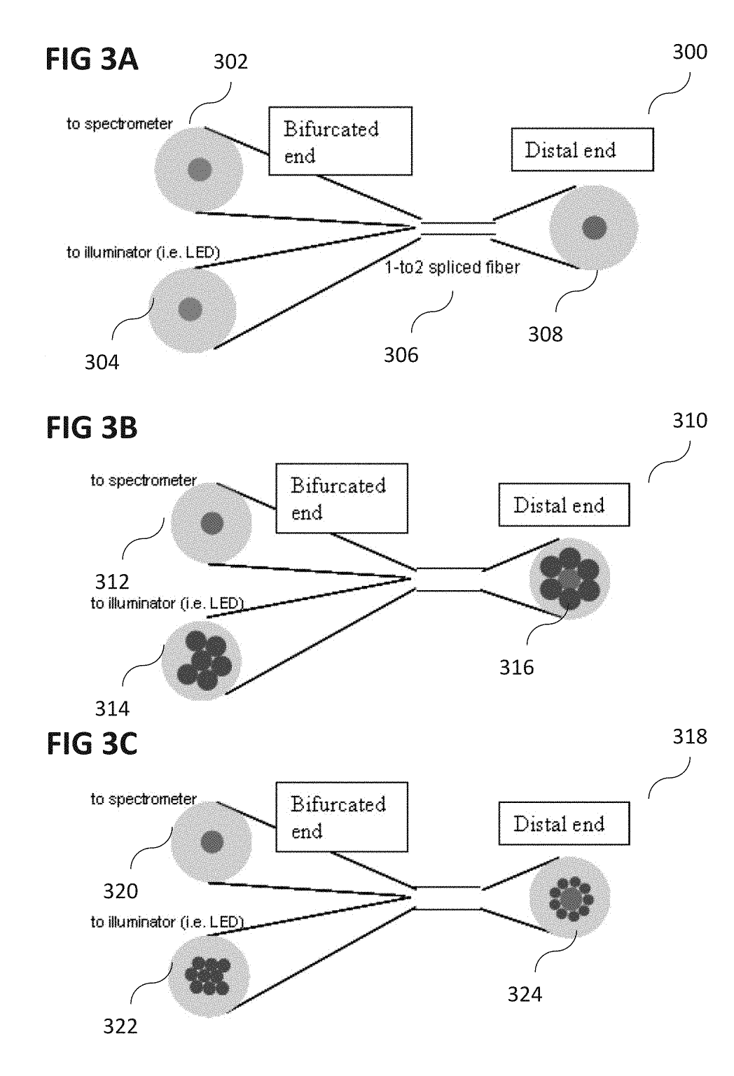

FIG. 3A, FIG. 3B, and FIG. 3C show schematic diagrams of three example of different fiber arrangements in the bifurcated fiber according to various embodiments.

The bifurcated fiber can come in various variant.

It can be a single core spliced fiber with example of 50:50 (or any ratio combination) transmission, for example like shown in illustration 300 of FIG. 3A. A 1-to-2-spliced fiber 306 may have a distal end 308, and a bifurcated end with an end provided to a spectrometer (end 302) and an end provided to an illuminator (end 304).

In another embodiments, a multiple fiber bundle configuration, like shown in illustration 310 of FIG. 3B may be provided, wherein one fiber end 314 of the bifurcated section may consist of a plurality, for example 6, single core fibers. The other fiber end 312 may consist of one single core fiber. The single core fiber may be connected to the spectrometer for spectral analysis. The LED may be connected to the 6 single core fibers. At the distal end 316 of the bifurcated fiber, the 7 fiber cores are arranged such that 6 of them are arranged in circular fashion surrounding the 7th fiber which is the collection fiber.

It will be understood that although the exemplary embodiment shown in FIG. 3B is described with 6 single core fibers in one end of the bifurcated section, any number of single core fibers may be provided. For example, like shown in the illustration 318 of FIG. 3C. The bifurcated end 322 provided to the illuminator includes 9 single core fibers. The bifurcated end 320 provided to the spectrometer may be identical or similar to the bifurcated end 314 provided to the illuminator shown in FIG. 3B. At the distal end 324 of the bifurcated fiber, the 10 fiber cores are arranged such that 9 of them are arranged in circular fashion surrounding the center 10th fiber which is the collection fiber.

For the measurement, light may be applied to the “illuminator” end of the bifurcated fiber, and the light output from the distal end of the fiber will be collimated using a suitable matching tube lens. The collimated light beam may then be re-directed, via a beamsplitter located in the fiber slider, to the back aperture of the objective. The latter may then be aligned and the image of the distal fiber arrangement focused onto the sample when the microscope camera is in focus.

With the illuminator (i.e. LED) turned ON, the exact position and size of the spot for signal collection (arrangement like shown in FIG. 2A) may be picked up by the microscope camera and stored prior to all ATR (or emission) micro-spectroscopy measurement.

With a multi-core fiber arrangement (for example with an arrangement like shown in FIG. 3B or shown with an arrangement like shown in FIG. 3C), both the bifurcated ends of the fiber may be illuminated and pre-measured and pre-stored, hence knowing the exact collection dimension and location relative to the “illuminator” cores. Thereafter, prior to each measurement with the illuminator (i.e. LED) turned ON, the image of the illuminator cores may be picked up by the microscope camera and matched to the stored “distal end” image to extract the exact position and size of the signal collection.

The illuminator may be then turned OFF during the spectrum or data acquisition to minimize interference.

Beamexpander modules either manually or motorized control may also be inserted before the distal end of the fiber, before or after Lens 216 for changing the size of the collection spot

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1.-12. (canceled)

13. An optical arrangement comprising:
a bifurcated fiber comprising a distal end and a bifurcated end;
wherein the bifurcated end comprises a first end configured to be connected to a detector and a second end configured to be connected to an illuminator; and
wherein the distal end is configured to provide an illumination spot on a sample, the illumination spot indicating a collection location.

14. The optical arrangement of claim 13, wherein the distal end comprises a single core fiber.

15. The optical arrangement of claim 13, wherein the bifurcated ends are connected to the distal end via a 1-to-2 spliced fiber.

16. The optical arrangement of claim 13, wherein the first end comprises a single core fiber.

17. The optical arrangement of claim 13,
wherein the second end comprises a single core fiber.

18. The optical arrangement of claim 13, wherein the distal end comprises a plurality of single core fibers, wherein a center single core fiber of the plurality of single core fibers of the distal end is connected to the first end, and wherein the center single core fiber is surrounded by single core fibers connected to the plurality of single core fibers of the second end.

19. The optical arrangement of claim 13, wherein the illuminator is a LED or a low power laser.

20. The optical arrangement of claim 13, wherein the detector is a spectrometer.

21. A method for controlling an optical arrangement, the method comprising:
illuminating a second end of a bifurcated end of a bifurcated fiber; and
collecting a signal from a first end of the bifurcated end of the bifurcated fiber;
providing an illumination spot on a sample using a distal end of the bifurcated fiber, the illumination spot indicating a collection location.

22. The method of claim 21, wherein the distal end comprises a single core fiber connected to the bifurcated ends via a 1-to-2 spliced fiber.

23. The method of claim 21, wherein the distal end comprises a plurality of single core fibers, wherein a center single core fiber of the plurality of single core fibers of the distal end is connected to the first end, and wherein the center single core fiber is surrounded by single core fibers connected to the plurality of single core fibers of the second end.

24. The method of claim 21, wherein the illuminator is one of a LED or a low power laser.

25. The method of claim 21, wherein the detector is a spectrometer.
